(19) United States
(12) Patent Application Publication
(10) Pub. No.: US 2018/0000042 A1
(43) Pub. Date: Jan. 4, 2018

(54) PET ENTERTAINMENT FRINGE CURTAIN STRIPS FOR PET HOUSING

(71) Applicant: Kim S. Ballentyne, Parike (BE)

(72) Inventor: Kim S. Ballentyne, Parike (BE)

(21) Appl. No.: 15/705,839

(22) Filed: Sep. 15, 2017

Related U.S. Application Data
(63) Continuation-in-part of application No. 15/192,641, filed on Jun. 24, 2016, now abandoned.
Application No. 15/192,641 is a continuation-in-part of application No. 14/015,327, filed on Aug. 30, 2013, now abandoned.
(60) Provisional application No. 61/812,108, filed on Apr. 15, 2013.
(60) Provisional application No. 62/534,864, filed on Jul. 20, 2017.

(51) Int. Cl. A01K 1/03; A01K 15/02

(52) U.S. Cl. CPC A01K 1/033; A01K 15/025

(57) ABSTRACT

A pet housing with pet entertainment fringe curtain strips is disclosed. An example pet housing with pet entertainment fringe curtain strips may include a housing having a support structure, and at least one passage formed therein for entry and exit of a pet. The pet housing with pet entertainment fringe curtain strips may also include a pet entertainment fringe curtain to at least partially cover the passage in the housing, the pet entertainment fringe curtain having a plurality of strips. The housing is configured to be oriented both upright and upside down so that the pet entertainment fringe curtain provides cover, a hiding place, a curtain from which to look out or through, shelter for the pet to relax and sleep in, and entertainment for the pet.

### PRIORITY CLAIM

This application claims the benefit of U.S. Provisional Patent Application No. 62/534,864 filed Jul. 20, 2017 titled “Pet Entertainment Fringe Curtain Strips For Pet Housing” of Kim S. Ballentyne, and this application is also a continuation-in-part (CIP) of U.S. patent application Ser. No. 15/192,641 filed Jun. 24, 2016 titled “Pet Toy And Shelter” of Kim S. Ballentyne, which is a continuation-in-part (CIP) of U.S. patent application Ser. No. 14/015,327 filed Aug. 30, 2013 titled “Pet Toy And Shelter” of Kim S. Ballentyne, which claims the priority benefit of U.S. Provisional Patent Application No. 61/812,108 filed Apr. 15, 2013 titled “Pet Toy And Shelter” of Kim S. Ballentyne, each hereby incorporated by reference in its entirety as though fully set forth herein.

### BACKGROUND

People have kept animals as pets to provide labor, companionship and entertainment. Persons with pets typically provide stimulation to these pets by training or playing with them. To enrich training and play, pet owners frequently make use of toys and other accessories that are a great way to keep a pet both physically and mentally active. Well known accessories include balls and noise makers. Additionally, to satisfy their pet's needs, pet owners look for a great combination of mental and physical exercise activities that provide plenty of healthy and safe stimulating fun and that bring out all the natural playful instincts of a pet. Furthermore, pet owners also search for pet accessories that relate to mimicking their pet's natural environment that instinctively keeps their pet's brains active and slows the deterioration to improve the quality of their life. Some pet owners also enjoy providing their pets with wearable accessories such as shirts, boots or backpacks.

### BRIEF DESCRIPTION OF THE DRAWINGS

FIGS. 1-4 are perspective views of the example pet housing with pet entertainment fringe curtain strips.

FIG. 5 illustrates example fringe curtain.

FIG. 6 illustrates scissor arms for example fringe curtain.

FIG. 7 illustrates example fringe curtain configured as bead chains.

FIG. 8 illustrates example fringe curtain configured as twisted strips with suspended objects.

FIG. 9 illustrates example fringe curtain configured with looped ribbons and bows.

FIG. 10 illustrates example fringe curtain attached with toggles.

FIG. 11 is a high-level block diagram of a control system for the pet toy and shelter.

FIG. 12 illustrates an example of attaching a fringe curtain with magnets.

FIG. 13 illustrates another example of attaching a fringe curtain.

FIG. 14 illustrates another example of attaching a fringe curtain.

### DETAILED DESCRIPTION

A pet housing with pet entertainment fringe curtain strips is disclosed herein as it may be provided for household pets, such as but not limited to cats. The example pet housing with pet entertainment fringe curtain strips may be used by anybody who passionately cares about his or her pet. The example pet housing with pet entertainment fringe curtain strips is safe, easy to assemble, provides endless hours of fun for pets and their owners, and can also be used as a sleeping area. It may also serve as a temporary and/or disposable and removable housing. It may be easily displayed in the store (e.g., at the checkout or point of sale zones) alone or with other existing pet toys and accessories. The example pet housing with pet entertainment fringe curtain strips has the ability to assume a collapsed state, making it easily transported and stacked for storage.

An example pet housing with pet entertainment fringe curtain strips may include a collapsible housing having a support structure that can and may evenly withstand the distributed weight to support the fringe curtains and mechanisms for attaching pet entertainment fringe curtains for a pet housing and may also have support feet and having a single and/or multiple layers of pet entertainment fringe curtain strips, and at least one passage formed therein for entry and exit of a pet. The fringe curtain may at least partially cover the passage in the housing. The housing is configured to be oriented both upright and upside down so that the pet entertainment fringe curtain provides cover, a hiding place, a curtain from which to look out or through, shelter for the pet to relax and sleep in, and plenty of entertainment for the pet.

The example pet housing with pet entertainment fringe curtain strips is described herein primarily with reference to its use with cats (or more generally, feline pets), although other animals or pets may also benefit from its use. In an example, the pet housing with pet entertainment fringe curtain strips is eco-friendly, and may be prefabricated from recycled cardboard or other recycled material. Also in an example, the pet housing with pet entertainment fringe curtain strips requires no batteries or electricity to use.

Before continuing, it is noted that as used herein, the terms “includes” and “including” mean, but is not limited to, “includes” or “including” and “includes at least” or “including at least.” The term “based on” means “based on” and “based at least in part on.”

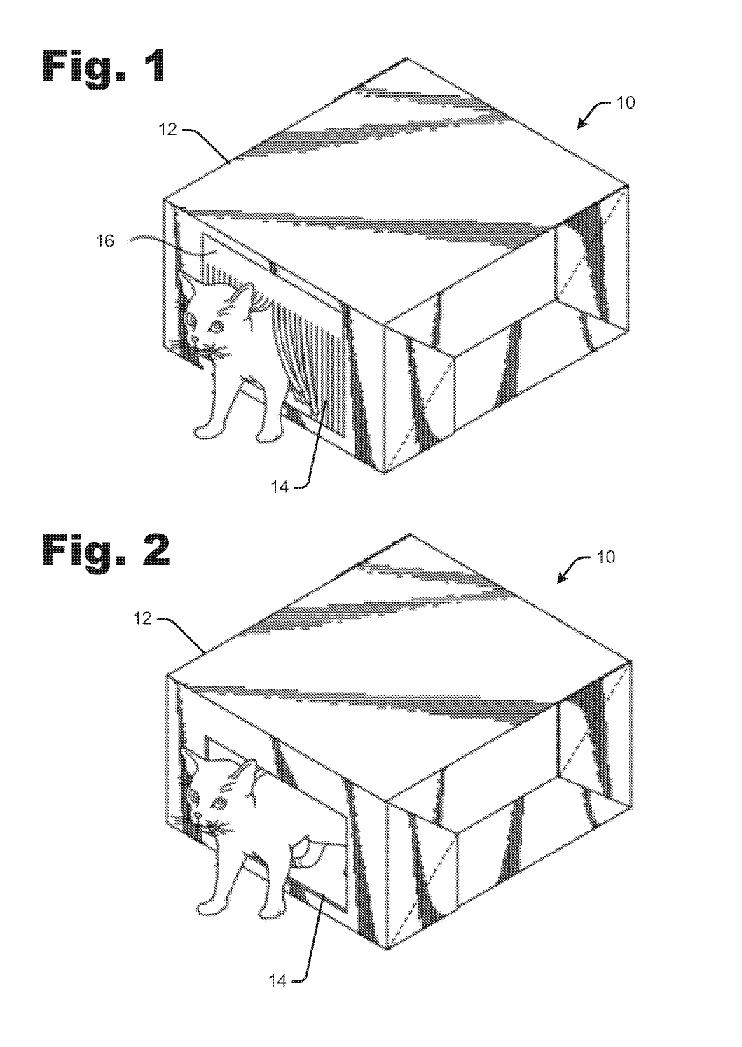

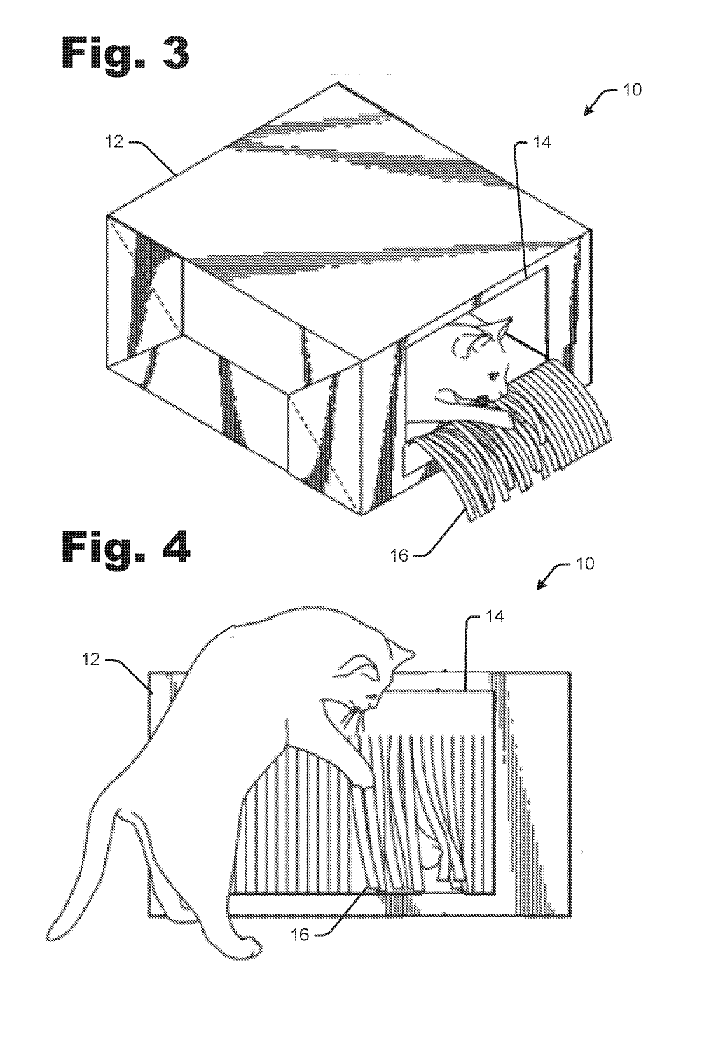

FIGS. 1-4 are perspective views of the example pet housing with pet entertainment fringe curtain strips 10. In an example, the pet housing with pet entertainment fringe curtain strips 10 includes a housing 12 which may be assembled by expanding or erecting a box from a collapsed state to an assembled configuration. The example pet housing with pet entertainment fringe curtain strips 10 may be returned to the collapsed state, if desired, for example for storage or transport.

In the unassembled or collapsed state, the housing 12 may assume a generally or substantially flat profile, thereby occupying a relatively small space. The example pet entertainment fringe curtain strips 10 may assume a prismatoid shape in the erect state, such as, for example, a rectangular prism, a pentagonal prism or a pyramid. Other shapes are also contemplated as being within the scope of the disclosure herein.

A passage or entryway 14 (e.g., an opening or hole) is formed through one or more sides of the housing 12, and may take any of a variety of shapes including but not limited to rectangular, square, octagonal, cylindrical, circular, semi-circular or triangular. Other shapes are also contemplated. Passage 14 may be any hole, opening, hollow space, or receptacle used to provide a hollow object such as a cavity, aperture, den, burrow, or gap.

In an example, passage 14 may be pre-cut into housing 12. In another example, perforations may be provided in the housing 12 for the end-user to form a selectable, but at least semi-custom size passage 12 in the housing 12. A smaller passage may thereby be created by the user for smaller pets, and a larger passage may be created by the user for larger pets. In yet other examples, housing 12 may be manufactured with demarcations indicating lines which the user may cut to provide passage 14. As with perforations, demarcations may be provided such that one of a variety of passage sizes may be selected by the end user. In an example, the user may change the size of the opening as the pet grows.

In an example, a fringe curtain 16 (or simply “fringe”) is attachable to housing 12 in any of a variety of locations, for example, adjacent to and at least partially covering passage 14. Fringe 16 may include an upper and/or lower base portion for attachment to the housing, and a plurality of individual flexible fibers or strips extending from the upper and/or lower base portion. When fringe 16 is coupled with housing 12 such that passage 170 is at least partially covered, a pet is able to pass through the fringe 16 when entering or exiting passage 170.

The example fringe 16 may include an outer covering for wrapping the housing 12 or portions thereof to provide a decorative motif. The outer covering may be applied inside and/or outside of the housing 12 and may be provided in any of a variety of materials including but not limited to paper or plastic. In an example, the outer covering may be provided integral to the housing 12 itself (e.g., the housing 12 may be painted or pre-coated with a covering). As with fringe 16, different outer coverings may be provided in a variety of colors and motifs.

In an example, a lining material may also be provided inside the housing 12, for example, as a coating. A lining may be water-proof or otherwise provide additional durability to the housing 12. As with the outer covering, different colors and motifs may be provided for the lining.

The example pet entertainment fringe curtain strips 16 may be entirely or partially constructed of materials (e.g., eco-friendly materials) such as cardboard and paper, and may be provided with a finish in any of a variety of colors, patterns, designs or motifs.

A variety of additional coloring sheets which may be selected and applied by an end user to provide additional beauty, e.g., as part of kit. In an example, the motif may be readily changed at the user's desire (e.g., for time of year, seasons, or area of use).

Although described herein as the example fringe curtain 16 may be constructed cardboard, the example fringe curtain 16 is not limited to manufacture of any particular type, color, or shape of material. In addition, the example fringe curtain 16 may come unassembled in any of a variety of different configurations, and in another example, may come pre-assembled upon purchase. Example fringe curtain 16 may be manufactured from plastic or coated with a plastic or similar material so as to be hygienic and may additionally or alternatively be formed of a material or otherwise constructed to be easily disposed of or recycled if worn or otherwise damaged.

Manufacturers may appreciate that the pet entertainment fringe curtain strips 10 may be easily manufactured and efficiently transported for sale locally or globally. In an example, the fringe curtain 16 does not even need extra packaging, and so it can be produced at a low cost and on demand as a complete, all-in-one, grab-and-go package or kit.

Before continuing, it should be noted that the examples described above are provided for purposes of illustration, and are not intended to be limiting. Other devices and/or device configurations may be utilized to carry out the operations described herein. Further examples include but are not limited to the pet entertainment fringe curtain 16 being incorporated with pet furniture, pet toys, pet accessories, and/or the fringe 16 being used in front of passages, entry ways, or entrances to other devices.

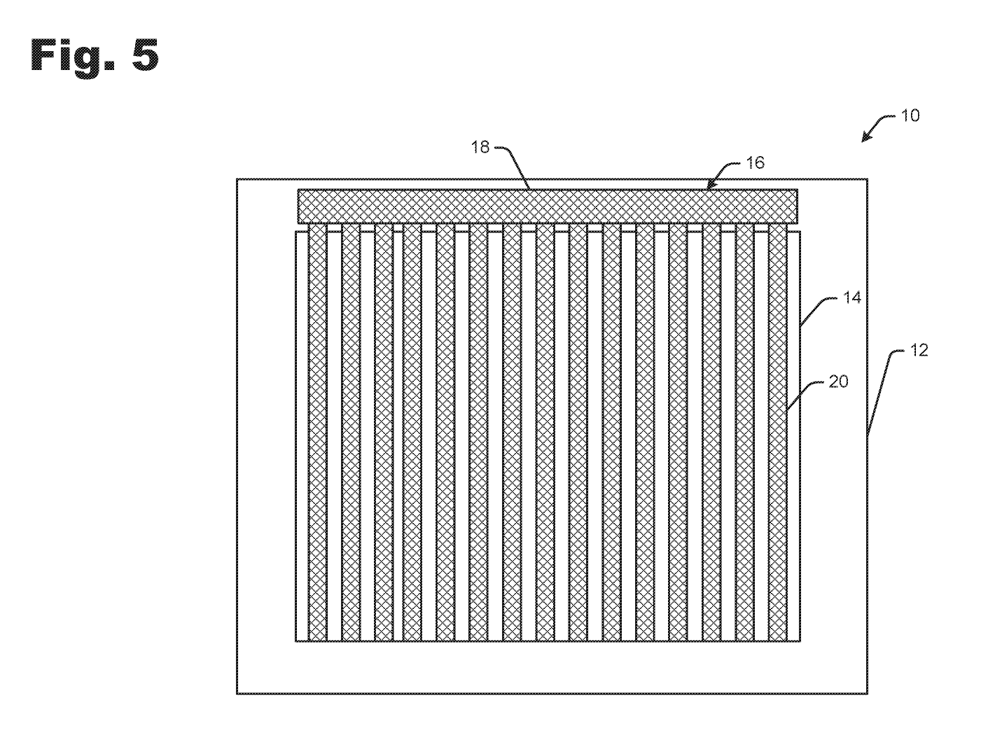

FIG. 5 illustrates example fringe curtain 16. In an example, the fringe 16 may include a base portion 18. Base portion 18 may include coupling (for detachably securing the fringe 16 to the housing 12 (e.g., to the outside and/or inside) of the passage 14. Any of a variety of couplings may be used including but not limited to, e.g., screws with wing nuts, pins, hook-and-loop fasteners, magnets, sewn, a sleeve and/or groove extending longitudinally, tapes, or adhesives. Adhesives may be pre-provisioned to the fringe 16, as by a material which becomes tacky by removing a film strip or upon application of moisture (such as with envelopes or postage stamps). In an example, the fringe 16 may be permanently affixed to housing 12 by a permanent adhesive, either by a manufacturer, supplier, by an end-user, or provided as an integral portion of the housing 12.

It should be noted that the fringe 16 can be incorporated in any other pet toys, furniture, accessories, etc. For example, the fringes may also be used with a climbing den, climbing pole, cat frame, cat tree, any form of cat toys using boxes or enclosures surrounded by a housing. In an example, the fringe 16 is attachable to an entry way, entrance or exit to any device, such as but not limited to, a housed or hooded box or an enclosed housing box.

The fringe 16 provides an unproblematic, safe, comfortable, simple, effective, easy to quietly maneuver even in use and/or in action, pet-friendly passage, entrance, entryway and exit for a pet to conveniently and privately access the housed box which automatically ensures privacy and allows sufficient air ventilation for pets to maintain their privacy and secrecy, and playful maneuvers. Indeed, more than one entryway or passageway and/or exit, may be provided, and fringe 16 may be provided on one or more of these passageways and/or exits.

The fringe 16 helps ensure that pets feel less vulnerable when they are sleeping because the pet can still have a view and see what is happening around them and be provided with a sense of comfort, security, and privacy.

Cats are almost neurotic about their need to feel safe and secure. Hooded or housed boxes incorporating the fringe 16 may provide cats with a quiet protected place. Young kittens and old geriatric cats with physical limitations may have difficulties using certain types of hooded boxes. A solid, swing or fixed permanent door or flap may prevent access or trap your pet inside the box housing, hooded box, or enclosure. The fringe 16 enables easy access for the pet and can be readily disposed of, replaced, and recycled to prevent diseases. For hygienic and sanitation purposes, the fringe 16 can be readily disposed of, replaced and recycled and prevent diseases.

Pets like to keep themselves clean and are conscious about their surroundings, and a place of refuse which is well concealed, provides shelter, and includes multiple labyrinths, constructed of intricate passageways, blind alleys, tunnels, and/or chambers which have non-restrictive escape routes between the hidden spaces and gaps which allows them to observe unnoticed and remain alert, due to the rustle sounds, and also be ready to pounce into action to catch and grab unsuspecting objects or prey that passes their entryway or exit or to escape.

The fringe 16 is a smart and stylish way to hide the entrance to the box and/or enclosure whilst still providing total privacy. The fringe 16 helps avoid anything that can cause box aversion by making it an attractive place for cats, Disguising the entrance or entryway or passageway to the box with the fringe and/or housing 12 also may serve as a piece of furniture or other decorative element that can be attractive and placed anywhere in the home or other environment.

In an example, the fringe 16 is provided with individual fibers or strips 20 that are pre-cut with soft cut edges, and separated from one another. In another example, the fringe 16 includes perforations between adjacent strips 20 to facilitate separation of strips 20 by tearing. In another example, the fringe 16 includes a plurality of demarcations indicative of cuts to be made by a user for separating a sheet into individual strips 20. It is noted that the strips 20 may be any size, may be cord or fiber, ribbon, brush, etc.

Fringe 16 may exhibit a variety of colors and motifs and may be constructed from paper, plastic, or any other suitable material (e.g., at least partially flexible material). In some examples, strips 20 of the fringe 16 may also be provided to include strings, beads, small chains and/or other dangling objects, in addition to or instead of strips or fibers 16. Example strips 20 may be beautiful, quirky, fun, edgy, stylish, simple, patterned, not patterned or a combination of these. In an example, motifs may be provided corresponding to seasons, sports teams, nationalities, or other (e.g., a logo may be provided at the base of fringe 16).

Components of pet entertainment fringe curtain strips 20 may be provided as a kit or system. In an example, the kit may be provided as a prefabricated flat pack design packaged together in a thin plastic wrapping, although other packaging is also contemplated. The kit may be provided in a convenient manner for purchase as a complete, grab-and-go package from a retailer or other supplier. The kit may also include instructions for subsequent and easy assembly by purchaser or other end-user.

The pet entertainment fringe curtain strips 16 may be utilized as a toy, a play and exercise apparatus, and a personal territory and secure shelter, e.g., for pets to sleep or rest in, or it may be used as an entryway or entrance way or passages to a housed or hooded box and/or as an enclosed box housing. Pets that use the pet entertainment fringe curtain 16 may live longer, healthier active lives. For example, the pet entertainment fringe curtain 16 may help keep pets mentally and physically sharp and may compliment other pet toys or products.

A fringe curtain 16 may be provided to at least partially cover the passage 14 in the housing 12 of the pet entertainment fringe curtain strips 10. In an example, the fringe curtain 16 has a plurality of strips. A valence may also be provided.

It is noted that the fringe curtain 16 may be made of any suitable material. Examples include, but are not limited to, laminated plastic, absorbent material, and fiberboard. It is also noted that the fringe curtain may be positioned inside or outside of the collapsible housing adjacent the passage. In addition, the fringe curtain 16 can be permanently or removably attached adjacent the passage 14. For example, the fringe curtain 16 can be removably attached with hook-and-loop fasteners (e.g., VELCRO™), groove slotted holder or sleeve, toggles, brackets, rods, poles, and pre-gummed adhesive.

It is noted that the strips may be varying thickness in both dimensions. Likewise, the strips may be of uniform or varying weight. The fringe curtain 16 may include different length strips. The fringe curtain 16 may also be formed as a brush. Still other examples are contemplated, as will be readily appreciated by those having ordinary skill in the art after becoming familiar with the teachings herein.

Prior to coupling fringe 16 to housing 12, adjacent strips/fibers may be separated. Separation of adjacent strips or fibers may include cutting along a plurality of demarcations provided between adjacent strips/fibers or may include tearing along a plurality of perforations provided between adjacent strips/fibers.

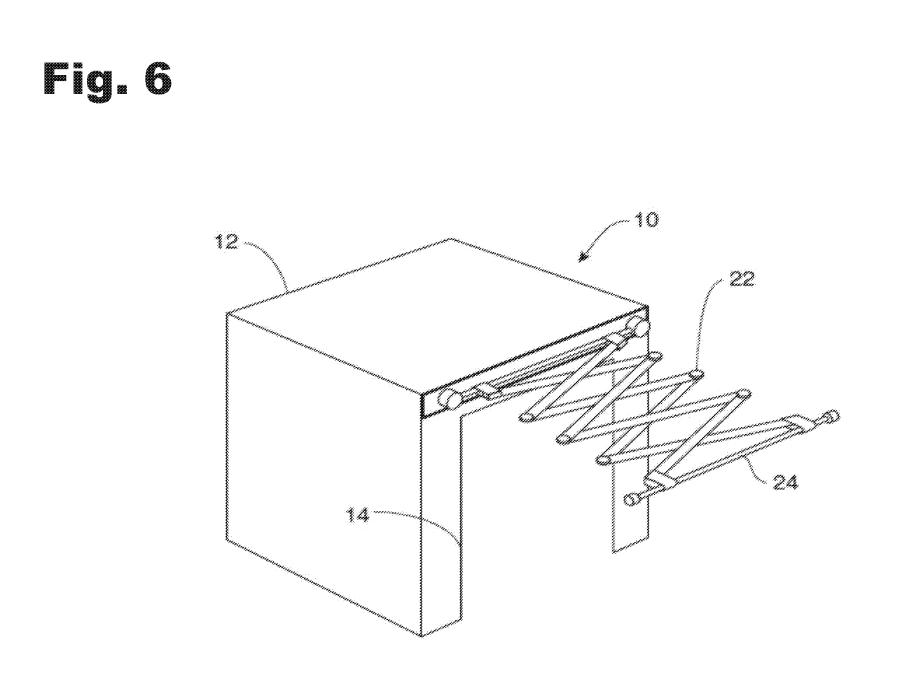

A variety of fringe curtains 16 may be supplied for at least partially covering the passage 14. As indicated above, coupling fringe 16 may include providing an adhesive such as glue to fringe base and/or the front facet and adhering the fringe 16 to the front facet or removing a protective strip from adhesive provided to the fringe 16 and adhering the fringe 16 to the front facet of the housing 12. In other examples, fringe 16 may be pinned to front facet of the housing 12. Other examples of fringe curtain 16 and implementations for attaching the fringe curtain 16 to the housing 12 are discussed with reference to FIGS. 6-10.

It should also be noted that the fringe curtain 16, although shown stationary, may also be moveable about at least a portion of the passage 16. For example, the fringe curtain 16 may slide back and forth across the passage 14 similar to a window curtain. Movement may be manual or controlled by a drive motor. Another example is described with reference to FIG. 6.

FIG. 6 illustrates scissor arms 22 for example fringe curtain 16. In an example, the scissor arms 22 may attach to the housing 12 adjacent the passage 14. The scissor arms 22 may movably attach the fringe curtain 16 to the housing 12. That is, the fringe curtain 16 may be attached to surface 24 of the scissor arms, and the scissor arms 22 are in turn attached to the housing 12.

In an example, the scissor arms 22 are manually operable to extend the fringe curtain 16 away from the passage 14. The scissor arms 22 may also be manually operable to retract the fringe curtain 16 toward the passage 14.

In another example, the scissor arms 22 are automatically operable (e.g., via battery operated motor) to extend the fringe curtain 16 away from the passage 14. The scissor arms 22 may also be automatically operable to retract the fringe curtain 16 toward the passage 14.

A control system for the motor may include control electronics such as, but not limited to a printed circuit board with a controller and memory operable to control a drive motor. The control electronics (e.g., controller, drive motor) may be provided in any suitable location, internal or external, to the pet entertainment fringe curtain strips 10.

In an example, the drive motor may automatically move the fringe curtain 16 via the scissor arms 22 to different positions. Driving the motor may be by any manner (e.g., a motion sensor, or a switch) and may be in response to movement of the fringe curtain 16, e.g., based on sensor input.

Any fringe curtain 16 may be implemented with the scissor arms 22. For example, the fringe curtain 16 shown in FIGS. 5 and 7-10 may be implemented with the scissor arms 22.

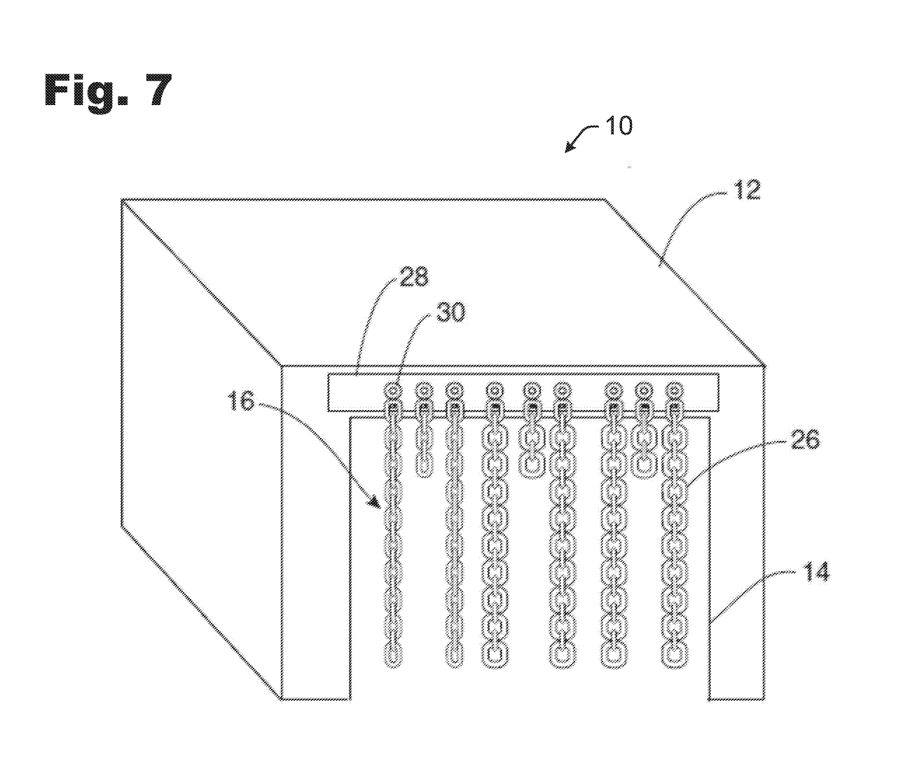

FIG. 7 illustrates example fringe curtain 16 configured as bead chains 26. In this example, the pet housing with pet entertainment fringe curtain strips 10 has a fringe curtain 16 that comprises bead chains 26. Of course, other configurations of the bead chains 26 are also contemplated, and the bead chains 26 shown in FIG. 7 is merely illustrative of one such example.

In an example, the plurality of bead chains 26 are attached to a mounting plate 28, which is attached to the housing 12 adjacent the passage 14.

In an example, the fringe curtain 16 is attached adjacent the passage 14 with a swivel pin 30. The swivel pin 30 may enable each of the rows of bead chains 26 to rotate at least partially. In an example, multiple rows of bead chains 26 may be attached to each swivel pin 30.

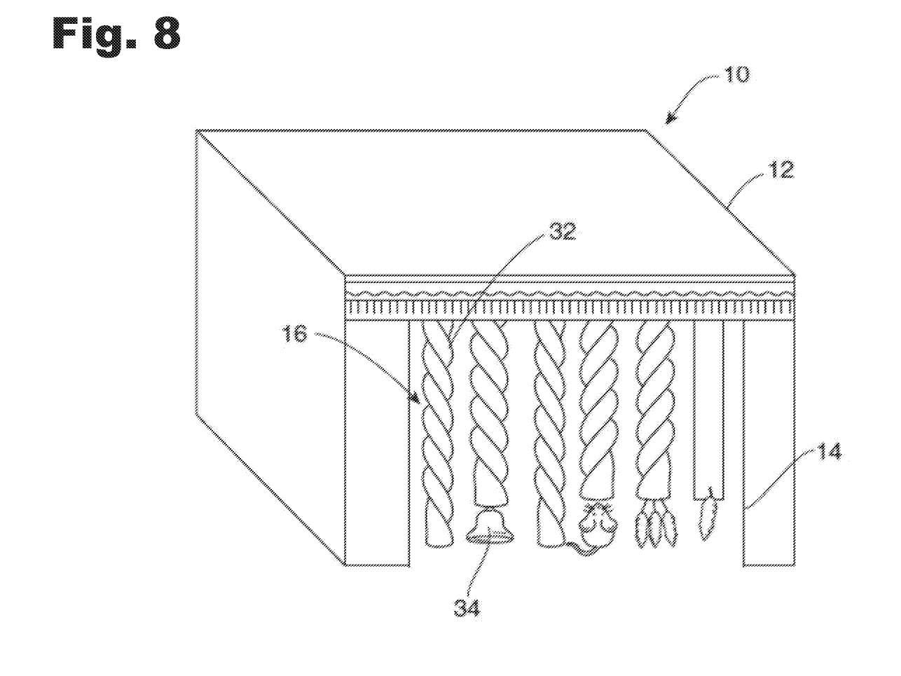

FIG. 8 illustrates example fringe curtain 16 configured as twisted strips with suspended objects. In this example, the pet housing with pet entertainment fringe curtain strips 10 has a fringe curtain 16 that comprises at least some twisted strips 32. In an example, the fringe curtain 16 includes all twisted strips 32. In another example, the fringe curtain 16 includes a mix of twisted strips 32 and untwisted strips. Of course, other configurations of the twisted strips 32 are also contemplated, and the fringe curtain 16 with twisted strips 32 shown in FIG. 8 is merely illustrative of one such example. The twisted strips 32 may be a uniform length, or different lengths across the fringe curtain 16.

Also shown in the example of FIG. 8, the pet housing with pet entertainment fringe curtain strips 10 has a fringe curtain 16 that comprises at least one object 34 on at least one of the twisted strips 32. In an example, the fringe curtain 16 includes objects 34 on each strip. In another example, the fringe curtain 16 includes a mix of objects 34 and strips without objects. The same object may be used, or different objects 34 may be provided on different strips. More than one object 34 may be provided on a single strip.

The objects 34 may be any size, shape, or type (e.g., bell, mouse, feathers), and made of any material (e.g., shiny metallic, plastic, etc.). Of course, other configurations of the object 34 are also contemplated, and the fringe curtain 16 with object 34 shown in FIG. 8 is merely illustrative of one such example.

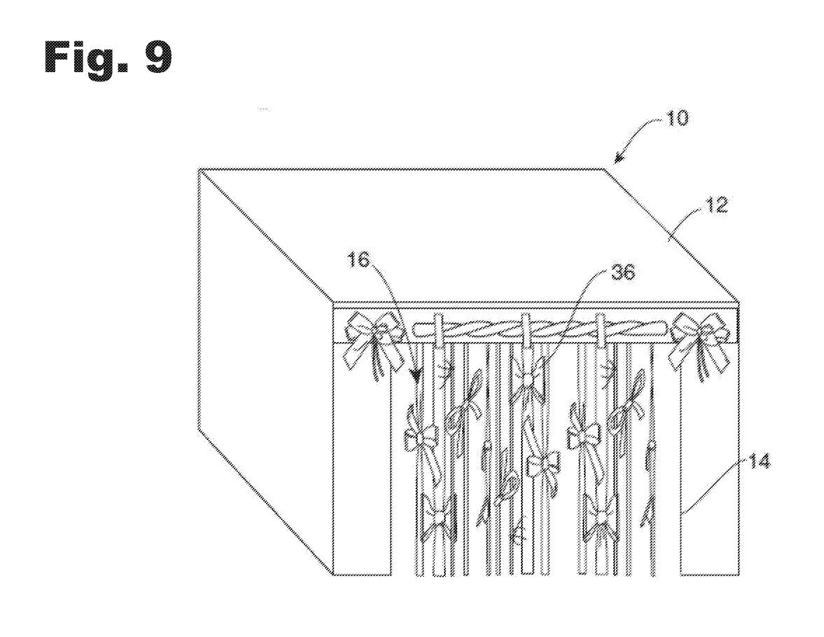

FIG. 9 illustrates example fringe curtain 16 configured with looped ribbons and bows. In this example, the pet housing with pet entertainment fringe curtain strips 10 has a fringe curtain 16 that comprises at least some looped ribbons or looped bows 36. In an example, the fringe curtain 16 includes all looped bows 36. In another example, the fringe curtain 16 includes a mix of looped bows 36 and other strips. Of course, other configurations of the looped bows 36 are also contemplated, and the fringe curtain 16 with looped bows 36 shown in FIG. 9 is merely illustrative of one such example. The looped bows 36 may be a uniform length, or different lengths across the fringe curtain 16.

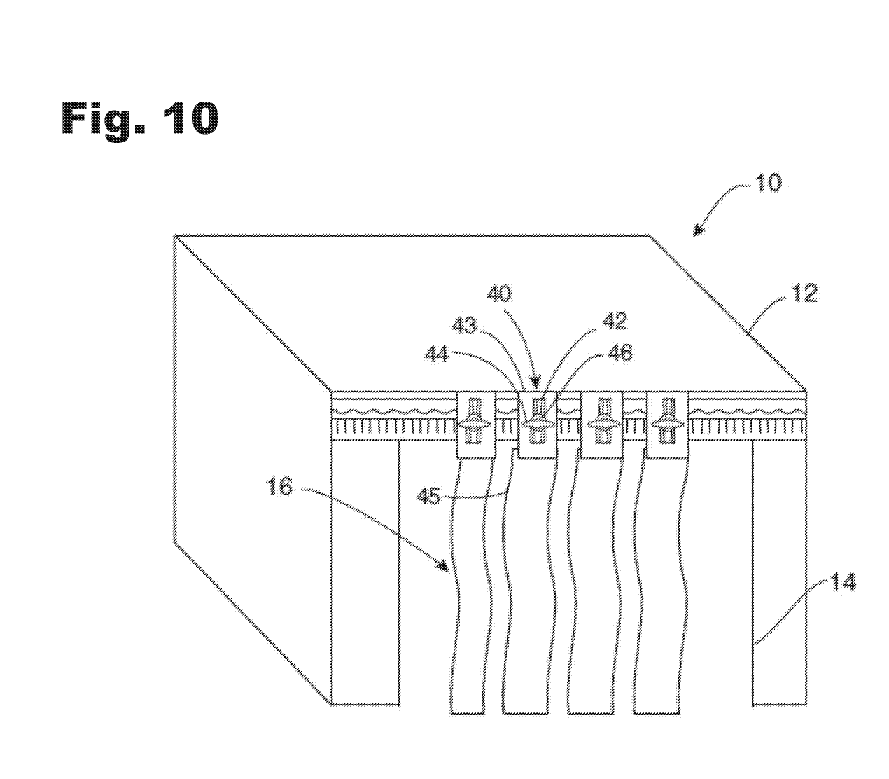

FIG. 10 illustrates example fringe curtain 16 attached with toggles 40. The attachment for toggles 40 may include a first tab 43 with a cord or rope 42 attached to a wood or plastic rod 44. The first tab 43 may be mounted to the housing 12 (or the plastic rod may be attached to a mounting strip that is attached to the housing 12, e.g., adjacent the opening 14). The toggle 40 may also include a cord formed as a loop 46. The loop 46 may be attached to the strip 45. It is noted that the rod 44 may instead be attached to the strip 45, and the loop 46 may be attached to the first tab 43. Still other configurations of the toggle 40 are also contemplated.

The toggles 40 may be assembled by inserting the rod 42 through the loop 46 (or through an opening formed in the strip 45), and then twisted to serve as a fastener. As such, the toggles 40 may fasten the strips 45 to the housing 12.

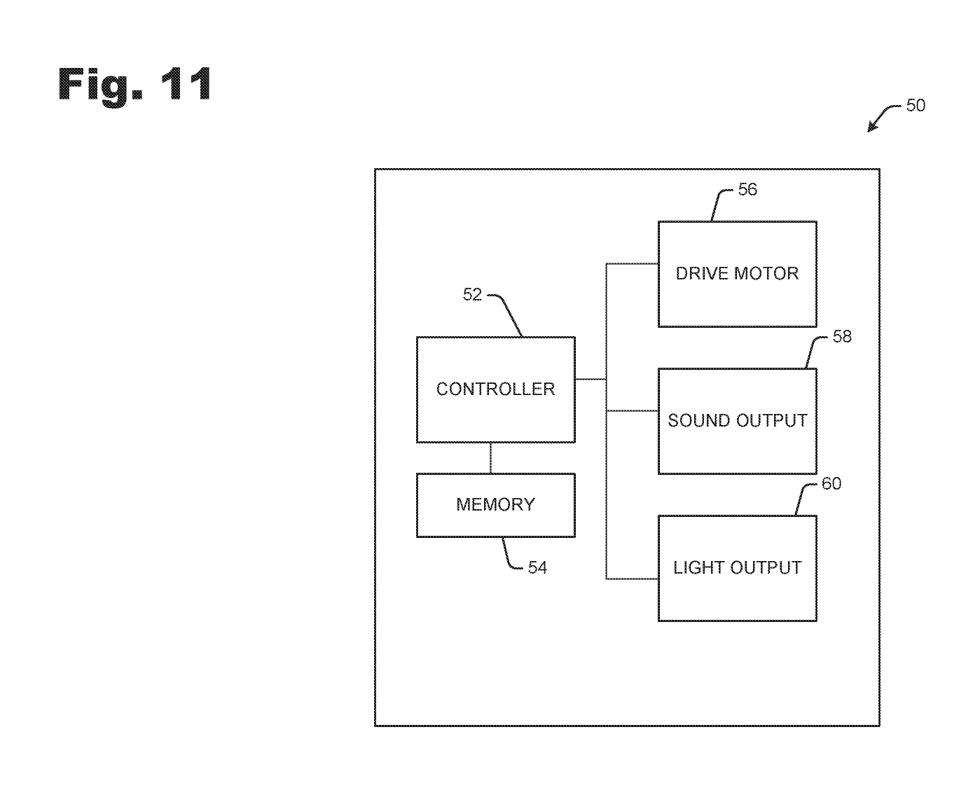

FIG. 11 is a high-level block diagram of a control system 50 for the pet toy and shelter. The control system 50 may include control electronics such as, but not limited to a printed circuit board with a controller 52 and memory 54 operable to control a drive motor 56, sound output 58 (e.g., speakers), light output 60 (e.g., lighting), and/or other controlled device (e.g., an electric fan). The control electronics may also be configured to control other devices not specifically mentioned, but commercially available now or in the future. The control electronics (e.g., controller, drive motor, sound and/or light output) may be provided in any suitable location, internal or external, to the pet toy and shelter.

In an example, the drive motor 56 may automatically move the fringe curtain to different positions. The output device 58 may be configured to output sound or other audio effect (e.g., the chirp of a bird). The output device 60 may be configured to output light or other visual effect. Output by any of the devices may be in response to movement of the fringe curtain, e.g., based on sensor input. Light and/or sound may include any of a variety of different types of light and/or sound, position of the light and/or sound, etc.

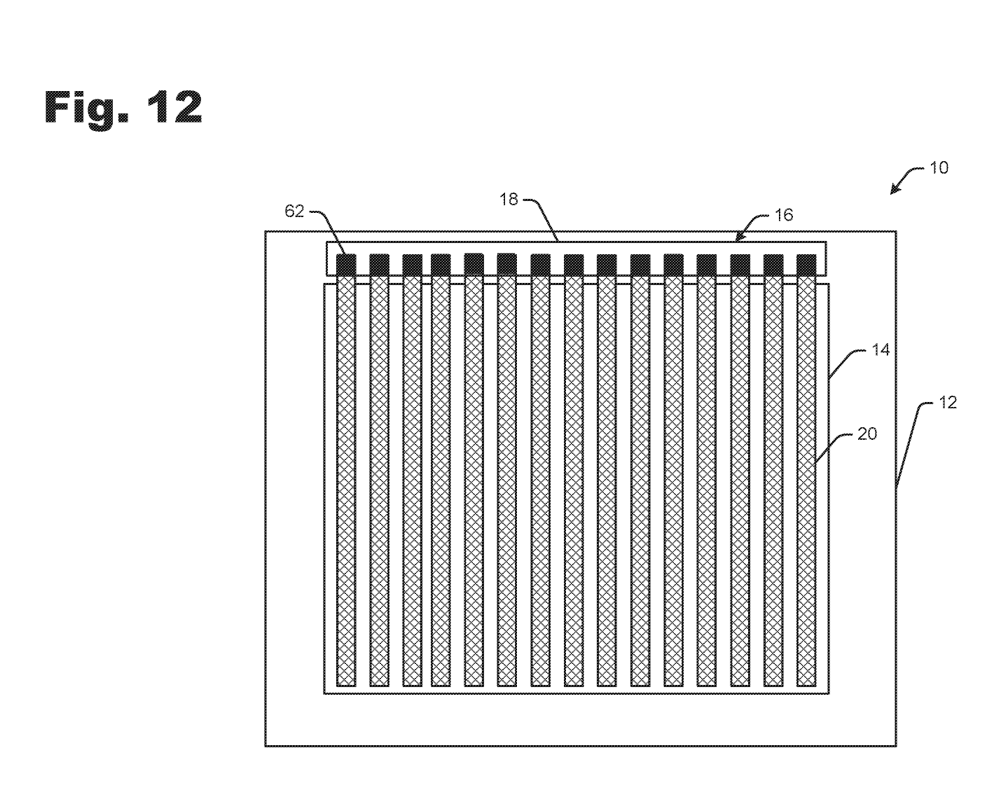

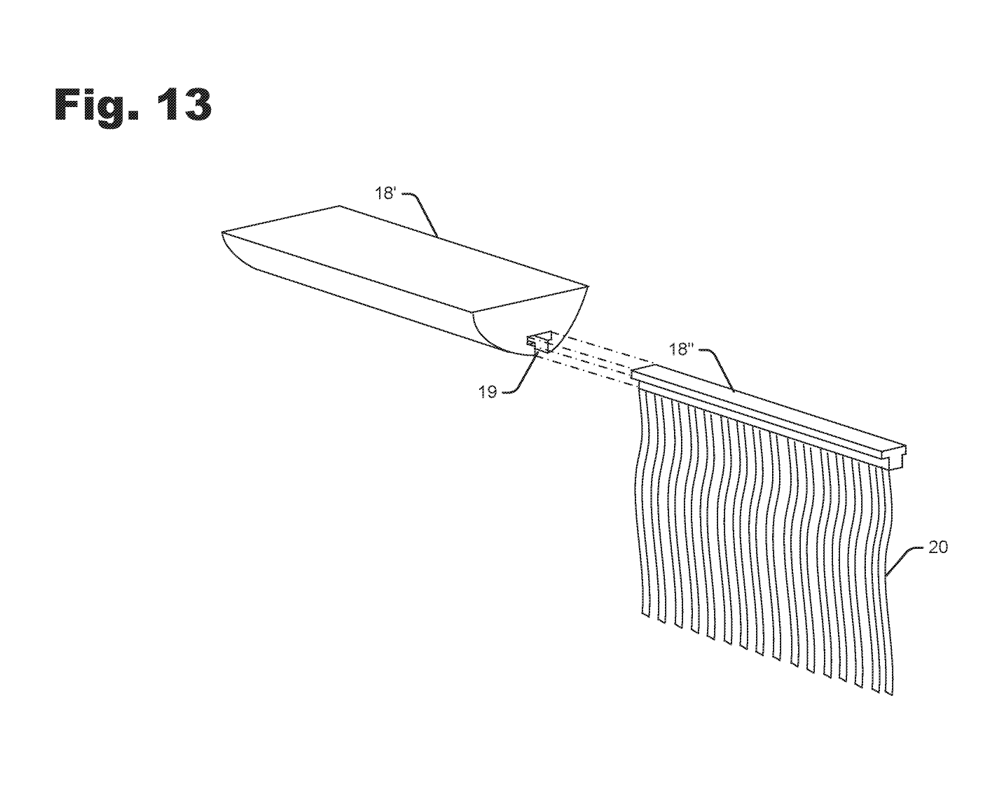

FIG. 12 illustrates an example of attaching a fringe curtain with magnets 62. In an example, each strip 20 has an individual magnet, which may attach to a metallic base portion 18. In another example, the strips 20 may include a metal tab (e.g., at 62) and the base portion may be magnetic. In another example, the strips 20 may be affixed to the base portion which is a magnet (or metallic) and attachable directly to the housing 12 (e.g., having a metal or magnetic portion). In an example, the magnets 62 (or where base 18 is a magnet) can be attached to the top of the housing 12 so that the strips 20 hang over the edge to cover the opening 14.

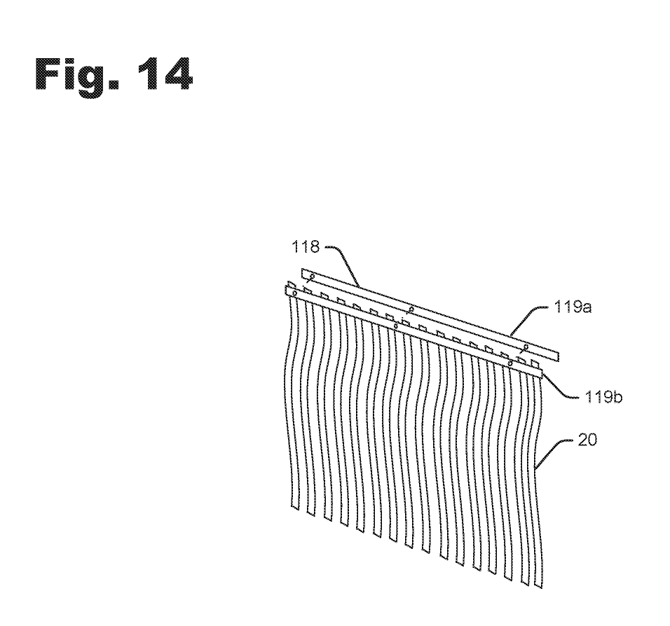

FIG. 13 illustrates another example of attaching a fringe curtain. In this example, the base portion 18′ includes a groove 19 (e.g., T-groove in this example). The groove 19 is configured to slidably receive mating base portion 18″ having strips 20 thereon. The base portion 18′ may be mounted adjacent the opening 14 in housing 12.

FIG. 14 illustrates another example of attaching a fringe curtain. In this example, the base portion 118 includes two bars 119a-b. The strips 20 may be inserted between the bars 119a-b and the bars 119a-b fastened together (e.g., by screw and nut, loop-and-hook, or other suitable fasteners) to hole the strips 20 therebetween. The base portion 118 may be mounted adjacent the opening 14 in housing 12.

It is noted that the examples shown and described are provided for purposes of illustration and are not intended to be limiting. Still other examples are also contemplated.

1. A pet housing with pet entertainment fringe curtain strips, comprising:
a housing having a support structure, and at least one passage formed therein for entry and exit of a pet; and
a pet entertainment fringe curtain to at least partially cover the passage in the housing, the pet entertainment fringe curtain having a plurality of strips;
wherein the housing is configured to be oriented both upright and upside down so that the pet entertainment fringe curtain provides cover, a hiding place, a curtain from which to look out or through, shelter for the pet to relax and sleep in, and entertainment for the pet.

2. The pet housing with pet entertainment fringe curtain strips of claim 1, further comprising scissor arms to movably attach the pet entertainment fringe curtain to the housing.

3. The pet housing with pet entertainment fringe curtain strips of claim 2, wherein the scissor arms are manually operable to extend the pet entertainment fringe curtain away from the passage and retract the pet entertainment fringe curtain toward the passage.

4. The pet housing with pet entertainment fringe curtain strips of claim 2, wherein the scissor arms are automatically operable to extend the pet entertainment fringe curtain away from the passage and retract the fringe curtain toward the passage.

5. The pet housing with pet entertainment fringe curtain strips of claim 1, wherein the pet entertainment fringe curtain comprises bead chains.

6. The pet housing with pet entertainment fringe curtain strips of claim 1, wherein a plurality of bead chains are attached to a mounting plate which is attached to the housing adjacent the passage.

7. The pet housing with pet entertainment fringe curtain strips of claim 1, wherein the pet entertainment fringe curtain is attached adjacent the passage with a swivel pin,

8. The pet housing with pet entertainment fringe curtain strips of claim 1, further comprising an object attached at an end of each strip of the pet entertainment fringe curtain.

9. The pet housing with pet entertainment fringe curtain strips of claim 1 wherein the pet entertainment fringe curtain includes a plurality of twisted strips.

10. The pet housing with pet entertainment fringe curtain strips of claim 1, wherein the pet entertainment fringe curtain includes a combination of twisted strips and untwisted strips.

11. The pet housing with pet entertainment fringe curtain strips of claim 1 wherein the pet entertainment fringe curtain includes a plurality of looped ribbons.

12. The pet housing with pet entertainment fringe curtain strips of claim 1, wherein the pet entertainment fringe curtain is attached with toggles.

13. The pet housing with pet entertainment fringe curtain strips of claim 12, wherein the toggles each comprise a rod attached to one side of a strip of the pet entertainment fringe curtain, the short rod pushed through an opening in a mount and twisted on an opposite side of the opening to attached the strip to the mount.

14. The pet housing with pet entertainment fringe curtain strips of claim 1, wherein the pet entertainment fringe curtain includes different weight strips.

15. The pet housing with pet entertainment fringe curtain strips of claim 1, wherein the pet entertainment fringe curtain is moveable about at least a portion of the passage.

16. The pet housing with pet entertainment fringe curtain strips of claim 1, wherein the pet entertainment fringe curtain includes at least one semi-rigid strip.

17. The pet housing with pet entertainment fringe curtain strips of claim 1, further comprising at least one valence.

18. A pet housing with pet entertainment fringe curtain strips, comprising:
a housing having a support structure, and at least one passage formed therein for entry and exit of a pet;
a pet entertainment fringe curtain to at least partially cover the passage in the housing, the pet entertainment fringe curtain having a plurality of strips; and
scissor arms to movably attach the pet entertainment fringe curtain to the housing.

19. A pet housing with pet entertainment fringe curtain strips, comprising:
a housing having a support structure, and at least one passage formed therein for entry and exit of a pet; and
a pet entertainment fringe curtain to at least partially cover the passage in the housing, the pet entertainment fringe curtain having a plurality of strips;
wherein the pet entertainment fringe curtain is attached with toggles.

20. The pet housing with pet entertainment fringe curtain strips of claim 19, the toggles each comprise a rod attached to one side of a strip of the pet entertainment fringe curtain, the short rod pushed through an opening in a mount and twisted on an opposite side of the opening to attached the strip to the mount.
